(19) United States
(12) Patent Application Publication
(10) Pub. No.: US 2026/0172736 A1
(43) Pub. Date: Jun. 18, 2026

(54) EAR-CLIP EARPHONE

(71) Applicant: Beijing Zitiao Network Technology Co., Ltd., Beijing (CN)

(72) Inventor: Shudong LIU, Beijing (CN)

(21) Appl. No.: 19/288,662

(22) Filed: Aug. 1, 2025

(30) Foreign Application Priority Data
Dec. 13, 2024 (CN) 202423095506.3
Dec. 13, 2024 (CN) 202423096059.3

(51) Int. Cl. H04R 1/10

(52) U.S. Cl. CPC H04R 1/105; H04R 1/1016

(57) ABSTRACT

The disclosure relates to the technical field of electronic products, in particular to an ear-clip earphone. The ear-clip earphone includes a speaker unit, a main body part and an ear clip part, where the speaker unit is adapted to be arranged on a front side of an ear, and the main body part is adapted to be arranged on a back side of the ear; both ends of the ear clip part are respectively connected to the speaker unit and the main body part, and the ear clip part is configured to switch between a first form and a second form, where in the first form, the speaker unit and the main body part jointly clamp the ear, and in the second form, the speaker unit abuts against the tragus.

### CROSS-REFERENCE TO RELATED APPLICATIONS

This application is based on Chinese application No.202423095506.3 with a filing date of December 13, 2024 and Chinese application No.202423096059.3 with a filing date of December 13, 2024, and claims their priority. The disclosure of these Chinese applications is hereby incorporated into this application as a whole.

### TECHNICAL FIELD

The disclosure relates to the technical field of electronic products, in particular to an ear-clip earphone.

### BACKGROUND

Ear clip headphones are clamped at the helix of the ear through a bendable bracket, which is small in size, does not cause compression to the ear canal, and has strong stability when clamped on the ear and is not easy to fall off.

However, the related ear clip headphone is single in form, which leads to the single wearing mode and acoustic effect, so that it cannot give consideration to both comfort and acoustic effect, and it is difficult to meet different needs of users.

### SUMMARY

In view of the above problems, the present disclosure provides an ear-clip earphone, which is beneficial to increasing the wearing modes of the ear-clip earphone and expand the application scenarios of the ear-clip earphone.

The disclosure provides an ear-clip earphone, which includes: a speaker unit adapted to be arranged on a front side of an ear; a main body part adapted to be arranged on a back side of the ear; and an ear clip part, both ends of which are respectively connected to the speaker unit and the main body part, and the ear clip part being configured to switch between a first form and a second form, where in the first form, the speaker unit and the main body part jointly clamp the ear, and in the second form, the speaker unit abuts against the tragus.

In some embodiments of the ear-clip earphone provided by the disclosure, where in the second form, the speaker unit further fits against an ear canal opening.

In some embodiments of the ear-clip earphone provided by the disclosure, where the ear clip part includes an pre-auricular segment located on the front side of the ear and an post-auricular segment located on the back side of the ear, and the pre-auricular segment is adapted to deform under an external force, to enable the ear clip part to switch between the first form and the second form.

In some embodiments of the ear-clip earphone provided by the disclosure, where when the ear clip part is in the first form, the pre-auricular segment protrudes outward in a direction away from the ear, and when the ear clip part is in the second form, the pre-auricular segment curves inward in a direction close to the ear, so that the speaker unit moves in a direction close to the tragus and the ear canal.

In some embodiments of the ear-clip earphone provided by the disclosure, where the ear clip part includes: a wrapping member; a deformation assembly arranged in an inner cavity of the wrapping member and located in the pre-auricular segment, the deformation assembly including: a first deformation member and a second deformation member, where both the first deformation member and the second deformation member are curved, and the second deformation member has a different bending radius from the first deformation member; the second deformation member is arranged in a stacked manner with the first deformation member and located on a side of the first deformation member facing away from the ear, both ends of the second deformation member are slidably connected to both ends of the first deformation member respectively, and the second deformation member is adapted for driving the first deformation member to deform under the action of the external force.

In some embodiments of the ear-clip earphone provided by the disclosure, where both ends of the first deformation member are respectively provided with limiting posts; both ends of the second deformation member are respectively provided with limiting slots corresponding to the limiting posts, and each limiting slot of the limiting slots is provided with a first limiting section and a second limiting section, which are arranged along an extension direction of the second deformation member and are connected; and the limiting posts (1343) are adapted for moving between the first limiting section and the second limiting section.

In some embodiments of the ear-clip earphone provided by the disclosure, where the limiting slot further includes a transition connecting section located between the first limiting section and the second limiting section, and a width of each of the first limiting section and the second limiting section is greater than a width of the transition connecting section.

In some embodiments, in the ear-clip earphone provided by the disclosure, where the limiting post includes: a post body adapted for being arranged to pass through the first limiting section and the second limiting section; and a limiting head arranged at a free end of the post body and is in limiting fit with the limiting slot.

In some embodiments of the ear-clip earphone provided by the disclosure, where the deformation assembly further includes a fixing sleeve, which is fitted around both ends of the first deformation member and the second deformation member, and is configured to limiting both ends of the first deformation member and the second deformation member.

In some embodiments of the ear-clip earphone provided by the disclosure, where both ends of the first deformation member are provided with first limiting slots, and both ends of the second deformation member are provided with second limiting slots; and the fixing sleeve is provided with a first limiting protrusion matched with the first limiting slot and a second limiting protrusion matched with the second limiting slot.

In some embodiments, a distance of the speaker unit from the ear canal opening in the first form is greater than a distance of the speaker unit from the ear canal opening in the second form.

In some embodiments, the pre-auricular segment includes a first ear clip component and a first deformation component, the post-auricular segment includes a second ear clip component, and the ear-clip earphone further includes: a locking member, one end of which is movably connected to the second ear clip component, and the other end of which is selectively connected to the first deformation component, so that the first deformation component and the locking member switch between a locked state and an unlocked state, where when the first deformation component and the locking member are in the locked state, the first deformation component is in the first form, and when the first deformation component and the locking member are in the unlocked state, the first deformation component is in the second form.

In some embodiments, the main body part is connected to an end of the second ear clip component away from the speaker unit; in the first form, the main body part and the speaker unit clamp the ear; and in the second form, the main body part extends below the tragus of the ear.

In some embodiments, when the locking member moves in a direction away from the first deformation component, the locking member is separated from at least part of the first deformation component, so that the first deformation component and the locking member are in the unlocked state; and when the locking member moves in a direction towards the first deformation component, the locking member is connected to the first deformation component, so that the first deformation component and the locking member are in the locked state.

In some embodiments, one end of the locking member is slidably arranged on the second ear clip component; or one end of the locking member is rotatably connected to the second ear clip component.

In some embodiments, one of the locking member and the second ear clip component is provided with a sliding protrusion, and the other of the locking member and the second ear clip component is provided with a sliding slot, and the sliding protrusion is slidably arranged in the sliding slot.

In some embodiments, when the first deformation component and the locking member are in the locked state, the locking member is located on the first deformation component and arranged to fit against the first deformation component.

In some embodiments, the first ear clip component is arranged on a side of the first deformation component away from the second ear clip component; and the other end of the locking member is selectively connected to the first ear clip component.

In some embodiments, when the first deformation component and the locking member are in the locked state, the locking member is arranged to fit against the first deformation component and at least part of the first ear clip component.

In some embodiments, one of the locking member and the second ear clip component is provided with a locking slot, and the other of the locking member and the second ear clip component is provided with an elastic protrusion; when the elastic protrusion is engaged in the locking slot, the first deformation component and the locking member are in the locked state.

In some embodiments, the ear-clip earphone further includes: a flexible housing, in which the second ear clip component and the first ear clip component are arranged in the flexible housing at an interval, and an area between the second ear clip component and the first ear clip component of the flexible housing constitutes the first deformation member.

In some embodiments, the post-auricular segment further includes a second deformation component arranged between the main body part and the second ear clip component, and an area of the flexible housing at a side of the second ear clip component away from the first ear clip component constitutes the second deformation component.

### BRIEF DESCRIPTION OF THE DRAWINGS

The accompanying drawings, which are incorporated in and constitute a part of this specification, illustrate embodiments consistent with this application and together with the description, serve to explain the principles of this application.

FIG. 1 is a schematic diagram of an ear provided by an embodiment of the present disclosure;

FIG. 2A is a schematic structural view of the ear clip part of the ear-clip earphone provided by the embodiment of the disclosure in a first form;

FIG. 2B is a schematic structural view of the ear clip part of the ear-clip earphone provided by the embodiment of the disclosure in a second form;

FIG. 3 is a structural schematic diagram of the deformation assembly of the ear-clip earphone provided by the embodiment of the disclosure;

FIG. 4 is a structural schematic diagram of the deformation assembly provided by the embodiment of the disclosure in the first form;

FIG. 5 is a structural schematic diagram of the deformation assembly provided by the embodiment of the disclosure in the second form;

FIG. 6 is a use state diagram of the deformation assembly provided by the embodiment of the disclosure in the first form;

FIG. 7 is a use state diagram of the deformation assembly provided by the embodiment of the disclosure in the second form;

FIG. 8 is a wearing schematic diagram of the ear-clip earphone provided by the embodiment of the disclosure in the first form;

FIG. 9 is a wearing schematic view of the ear-clip earphone provided by the embodiment of the disclosure in the second form;

FIG. 10 is a schematic diagram of an earphone provided by an embodiment of the present disclosure in the first form;

FIG. 11 is a schematic diagram of an earphone in an unlocked state provided by an embodiment of the present disclosure;

FIG. 12 is a schematic diagram of an earphone provided by an embodiment of the present disclosure in the second form;

FIG. 13 is an internal schematic diagram of the earphone provided by the embodiment of the present disclosure in the first form;

FIG. 14 is an internal schematic diagram of the earphone provided by the embodiment of the present disclosure in an unlocked state;

FIG. 15 is an internal schematic diagram of the earphone provided by the embodiment of the present disclosure in the second form;

FIG. 16 is a schematic diagram of the earphone worn on the ear and in a first wearing state provided by the embodiment of the present disclosure;

FIG. 17 is a schematic diagram of the earphone worn on the ear and in a second wearing state provided by the embodiment of the present disclosure.

### DESCRIPTION OF REFERENCE CHARACTERS:

100- ear-clip earphone; 110- speaker unit; 120- main body part; 130- ear clip part; 131- pre-auricular segment; 132- post-auricular segment; 133- wrapping member; 134- deformation assembly; 1341- first deformation member; 1342- second deformation member; 1343- limiting post; 1343a- post body; 1343b- limiting head; 1344- limiting slot; 1344a- first limiting section; 1344b- second limiting section; 1344c-transition connecting section; 1311- first ear clip component; 1312- first deformation component; 1321- second ear clip component; 1322- second deformation component; 200- locking member; 150 - locking slot; 160 - elastic protrusion; 10- ear; 11- helix; 12- concha; 13- tragus; 14- antitragus; 15- antihelix; 16- triangular fossa; 17- crus of helix; 18- ear canal opening; 19- earlobe; 121- concha cavity; 122- cymba concha; 151- upper crus of antihelix; 152- lower crus of antihelix.

Through the above drawings, a clear embodiment of the disclosure has been shown, which will be described in more detail later. These drawings and written descriptions are not intended to limiting the scope of the concept of the disclosure in any way, but to explain the concept of the disclosure to those skilled in the art by referring to specific embodiments.

### DETAILED DESCRIPTION

Reference will now be made in detail to exemplary embodiments, examples of which are illustrated in the accompanying drawings. When the following description refers to the drawings, unless otherwise indicated, the same numbers in different drawings indicate the same or similar elements. The embodiments described in the following exemplary embodiments do not represent all embodiments consistent with this application. Rather, they are merely examples of devices and methods consistent with some aspects of the disclosure as detailed in the appended claims.

In the related art, the speaker unit of the ear-clip earphone is far away from the ear canal, so that the sound quality of the audio played by the earphone is seriously damaged when entering the ear canal, and it is difficult to hear the sound played in the earphone clearly in a noisy environment.

In view of this, the present disclosure provides an ear-clip earphone, which includes a speaker unit, a main body part and an ear clip part, where the speaker unit and the main body part are located on two sides of the ear respectively, and both ends of the ear clip part are respectively connected to the speaker unit and the main body part. When the ear clip part is in the first form, the speaker unit and the main body part jointly clamp the ear, so that the stability is good and it is not easy to fall off, and further, there is a gap between the speaker unit and the ear canal of the ear, so that the speaker unit does not directly press the ear canal, and the damage to the ear canal is small. At the same time, in the first form, the speaker unit is not in contact with the tragus, so that the sound of the external environment will not be completely isolated, and the user can hear the sound of the external environment while hearing the sound emitted from the speaker unit, thus keeping alert to the environment. However, when the sound of the external environment is loud, it will affect the audio played by the speaker unit, resulting in serious damage to the sound quality, or the sound in the speaker unit is small, which makes it difficult for the user to hear clearly, affecting the use experience of the ear-clip earphone, and it is also easy to cause discomfort to the user's auricle when the speaker unit and the main body clamp the ear for a long time, so that the second form of the ear clip part is provided, in which the speaker unit abuts against the tragus and the ear-clip earphone is fixed on the ear by the speaker unit, whereby, the speaker unit is closer to the ear canal, so that the loss of audio played by the speaker unit in the propagation process can be reduced, the sound quality can be improved, and at the same time, the sound of the external environment can be better isolated, ensuring that the user can clearly hear the sound played by the speaker unit, so that it can be applied to noisy environments. Therefore, the ear-clip earphone provided by the disclosure has the advantages that when the ear clip part is in the first form, it is more comfortable for the user to wear, has less damage to the ear canal, and is adapted for a quieter environment; when the ear clip part is in the second form, the pressure on the user's auricle is less, the audio played by the speaker unit is better in sound quality, and the sound of part of the external environment can be isolated, so that the user can hear the sound played by the speaker unit more clearly. Therefore, the user can switch the ear clip part between the two forms according to the actual use requirements and the use environment, which enriches the wearing mode and the acoustic effect, and is beneficial to expanding the use scene of the ear-clip earphone.

The technical solution of this application and how the technical solution of this application can solve the above technical problems will be described in detail with specific examples. The following specific embodiments can be combined with each other, and the same or similar concepts or processes may not be repeated in some embodiments. Embodiments of the disclosure will be described below with reference to the accompanying drawings.

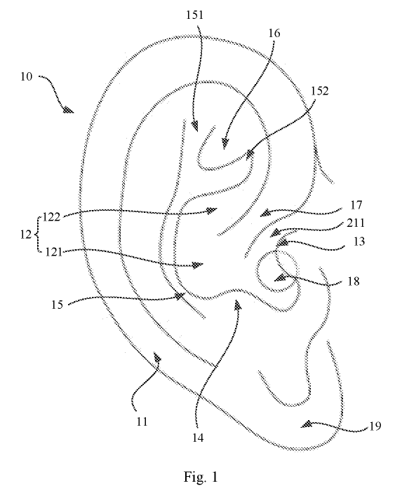

In order to clearly describe the wearing form of the earphone, the structure of the ear will be described first with reference to FIG. 1.

Referring to FIG. 1, the user's ear 10 includes such structures as helix 11, concha 12, tragus 13, antitragus 14, antihelix 15, upper crus of antihelix 151, lower crus of antihelix 152, triangle fossa 16, crus of helix 17, ear canal opening 18, earlobe 19, etc., where the concha 12 may include a cymba concha 122 and a concha cavity 121.

The front and back sides of the ear are defined as follows: "the front side of the ear" described in this disclosure is a concept relative to "the back side of the ear", the former refers to the side of the ear facing away from the head, and the latter refers to the side of the ear facing the head.

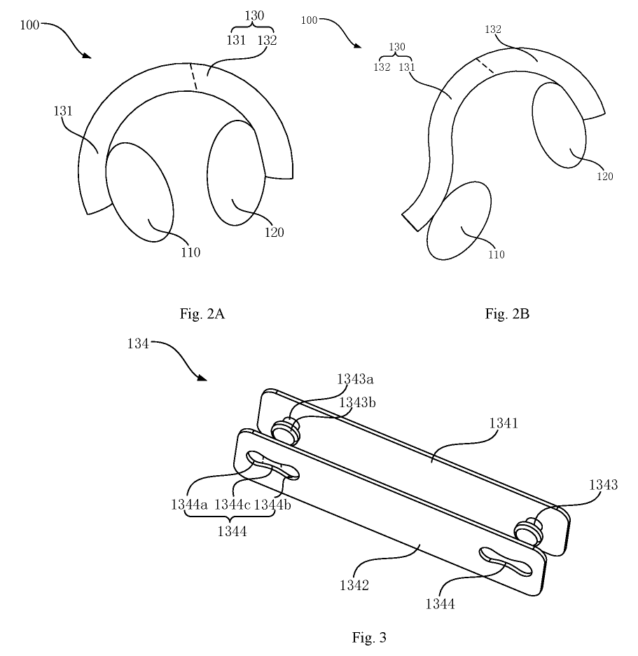

Referring to FIGS. 2A and 2B, some embodiments of the disclosure provide an ear-clip earphone 100, which includes a speaker unit 110, a main body part 120 and an ear clip part 130.

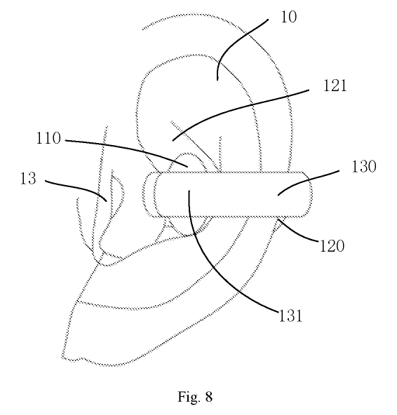

The speaker unit 110 is configured to generate sound, and it is located on the front side of the ear 10 when it is worn. For example, the speaker unit 110 can be located in the concha cavity 121 (as shown in FIG. 8), and the speaker unit 110 can at least include a speaker unit and a microphone unit. The speaker unit is mainly configured to convert electrical signals into sound signals, so as to facilitate the earphone wearer to receive sound; the microphone unit can be configured to capture the sound emitted by the earphone wearer and convert the sound signal into an electrical signal for transmission to another device. It can be understood that in order to facilitate sound generation, the housing of the speaker unit 120 may be provided with at least one sound outlet (not shown), which is acoustically coupled with the speaker unit, so that when the speaker unit 120 is located on the front side of the ear, the sound can be transmitted to the ear cavity of the ear through the sound outlet, so that the user can hear the corresponding sound information.

In some cases, according to the volume of the housing of the speaker unit 110, an electronic control unit may be arranged in the speaker unit, which may include a circuit board, a processor, a communication module and the like. For example, the circuit board may be a flexible printed circuit board (FPC), printed circuit board (PCB), etc., and the communication module may be a Bluetooth module, a Wifi module, a cellular module, etc. The electronic control unit is connected to the speaker unit and the microphone unit respectively, and the electronic control unit can be configured for realizing circuit control, controlling the working state of the speaker, such as adjusting the volume, controlling start and stop of the speaker, controlling the working state of the microphone unit, and further, communicating with the outside.

Accordingly, when worn, the main body part 120 is located on the rear side of the ear 200, and the main body part 120 can at least be configured for the arrangement of a battery. Of course, the above-mentioned electronic control unit can also be arranged in the ear clip part 130, and this is not limited by the embodiment of this application.

In this example, the main body part 120 and the speaker unit 110 are located on both sides of the ear clip part 130, so that the weight of the main body part 120 and the weight of the speaker unit 110 can be matched with each other by placing the battery of the earphone 100 in the main body part 120, which is helpful to realize the overall weight balance of the earphone 100, and the user can feel more balanced stress when wearing it, thus reducing the sense of oppression caused by uneven weight distribution. At the same time, the design of the main body part 120 is also helpful to enhance the stability of the earphone 100 on the head and reduce the risk of accidental falling off. The ear clip part 130, as an essential component of the earphone 100, is configured for connecting the speaker unit 110 and the main body part 120 of the earphone 100 and for wiring the earphone 100. In any form, the ear clip part 130 straddles the helix 11 of the ear 10 and clamps the helix 11, so that the earphone 100 is an ear-clip earphone.

Both ends of the ear clip part 130 are respectively connected to the speaker unit 110 and the main body part 120. Wires for electrically connecting elements in the main body part 120 with elements in the speaker unit 110 can be arranged in the ear clip part 130, and a flexible printed circuit board can also be arranged in the ear clip part 130 to control the working modes of speaker and microphone, which can change with the shape of the ear clip part 130.

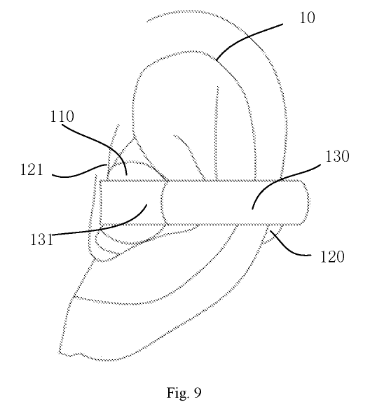

Further, the ear clip part 130 is configured to be switchable between a first form and a second form. In the first form, the speaker unit 110 and the main body part 120 jointly clamp the ear 200, whereby, the ear-clip earphone 100 mainly clamps the auricle through the speaker unit 110 and the main body part 120 so as to be fixed on the ear 200. In this form, the speaker unit 110 is far away from the ear canal, and the ear canal is less compressed, so that there is less damage to the ear canal, and the ear-clip earphone 100 can be used as an open earphone, as shown in FIG. 8. In addition, since the speaker unit 110 is far away from the ear canal here, the sound of the external environment can be directly introduced into the ear canal, so that the ear clip part 130 is more adapted for a quiet environment in the first form, and the user can hear the external sound without affecting the user's auditory experience, which is beneficial to keeping alert to the external environment or responding to emergencies in time; in the second form, the speaker unit 110 abuts against the tragus 13, whereby, the ear-clip earphone 100 is mainly fixed on the ear 200 through the speaker unit 110, and the ear clip part 130 and the main body part 120 are only in contact with the auricle, which functions to assist in position limiting. Therefore, the pressure of the ear-clip earphone 100 on the auricle in the second form is relatively small, and at the same time, the speaker unit 110 in the second form is closer to the ear canal. The sound played by the speaker of the speaker unit 110 can be transmitted into the ear canal more quickly, so as to reduce the loss of sound in the transmission process, improve the sound quality, and thus improve the user's experience. At the same time, since the speaker unit 110 abuts against the tragus 13, it can better isolate the external sound, so that it can be adapted for noisy environments and ensure that the user can clearly hear the sound played by the speaker unit 110, whereby the ear-clip earphone 100 can be used as an in-ear earphone, as shown in FIG. 9.

In the embodiment of the disclosure, the form of the ear clip part 130 can be adjusted according to the external environment or the user's demand for acoustic effects. When the user is in a quiet environment or needs to hear the sound of the external environment while listening to the sound played by earphones, the ear clip part 130 can be adjusted to the first form, and when the user needs higher sound quality or is in a noisy environment, the ear clip part 130 can be adjusted to the second form.

In addition, the wearing mode of the ear-clip earphone 100 can be adjusted according to the comfort. When the ear clip part 130 is in the first form, the user's auricle may suffer from pain when the speaker unit 110 and the main body part 120 clamp the user's auricle for a long time. At this time, the ear clip part 130 can also be adjusted to the second form to relieve the pressure on the auricle. When the ear clip part 130 is used as an in-ear earphone in the second form, the speaker unit 110 presses the ear canal opening for a long time, which may cause discomfort to the ear canal of the user. At this time, the ear clip part 130 can be adjusted to the first form to keep the speaker unit 110 away from the ear canal opening. Therefore, by adjusting the ear clip part 130 to the first form and the second form for alternate use, the problem of local discomfort to the ear 200 caused by long-term single wearing mode of the ear-clip earphone 100 can be alleviated, and the user's comfort in wearing the ear-clip earphone 100 can be improved by enriching the wearing modes of the ear-clip earphone 100.

Therefore, the ear-clip earphone 100 provided by the embodiment of the disclosure has various forms, and can adapt to different environments and user's use requirements by adjusting the form of the ear clip part 130, which can not only ensure the wearing comfort of the ear-clip earphone 100, but also realize different acoustic effects, thereby playing high-quality audio according to the user's needs, which is beneficial to improving the user's use experience and meeting different needs of the user, and further expanding the application scenarios of the ear-clip earphone 100.

In some realizable ways, as shown in FIG. 2B, in the ear-clip earphone 100 of the embodiment of the disclosure, when the ear clip part 130 is in the second form, the speaker unit 110 further fits against the ear canal opening.

In this way, the sound of the speaker unit 110 can be introduced into the ear canal more quickly, and at the same time, the sound of the external environment is isolated, so that the loss of sound is reduced, thereby improving the sound quality. The speaker and sound outlet in the speaker unit 110 can be arranged near the ear canal opening in the second mode, which can ensure that the sound can be directly transmitted into the ear canal and further improve the sound quality.

In some realizable ways, as shown in FIGS. 2A and 2B, the ear clip part 130 of the embodiment of the disclosure includes an pre-auricular segment 131 located on the front side of the ear 200 and an post-auricular segment 132 located on the back side of the ear 200, and the pre-auricular segment 131 is adapted to deform under an external force to switch the speaker unit 110 between the first form and the second form.

In practical implementation, in order to ensure that the main body part 120 fits against the back side of the ear 200 in both first and second forms, and to maintain the stability of the ear-clip earphone 100, it is necessary to arrange that the shape of the post-auricular segment 132 in the first and second forms remains unchanged, and the position of the speaker unit 110 at the front side of the ear 200 is adjusted only by changing the shape of the pre-auricular segment 131. By arranging that the pre-auricular segment 131 can deform directly by an external force, so that when the user actually uses the ear-clip earphone 100, the user can switch the ear clip part 130 between the first form and the second form only by pressing the pre-auricular segment 131, which is convenient to operate, helpful for the user to adjust at any time, and improves the flexibility of the ear-clip earphone 100.

In addition, when the circuit board or other elements in the ear-clip earphone 100 need to be arranged in the ear clip part 130, they can be arranged in the ear rear part 132, and the shape of the ear rear part 132 remains basically unchanged, so that the deformation of the pre-auricular segment 131 can be avoided from damaging the circuit board, and the specific layout of the circuit board and other elements in the ear-clip earphone 100 is not limited in this embodiment of the disclosure.

In some realizable ways, as shown in FIGS. 2A and 2B, in the ear-clip earphone 100 of the embodiment of the disclosure, when the ear clip part 130 is in the first form, the pre-auricular segment 131 protrudes outward in the direction away from the ear 200, and when the ear clip part 130 is in the second form, the pre-auricular segment 131 curves inward in the direction close to the ear 200, so that the speaker unit 110 moves in the direction close to the tragus 13 and the ear canal.

It can be understood that when the ear clip part 130 is in the first form, the pre-auricular segment 131 and the ear rear part 132 are smoothly connected to jointly form an arc, so that the speaker unit 110 and the main body part 120 can be stably clamped on the ear 200. By pressing the pre-auricular segment 131, the pre-auricular segment 131 curves inward in the direction close to the ear 200, so that when the ear clip part 130 is switched to the second form, one end of the pre-auricular segment 131 connected to the post-auricular segment 132 remains motionless, so that the speaker unit 110 will move in the direction close to the tragus 13 with the other end of the pre-auricular segment 131 until it abuts against the tragus 13.

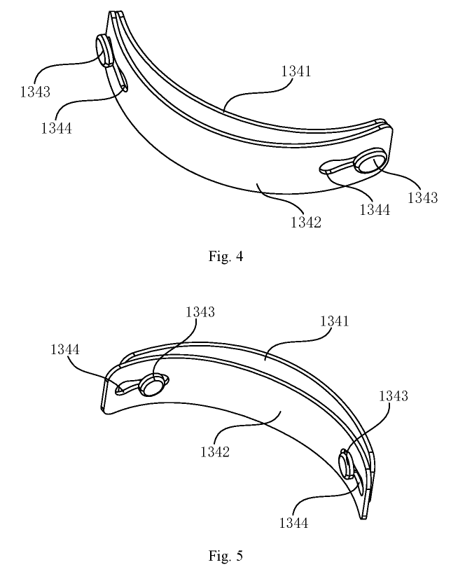

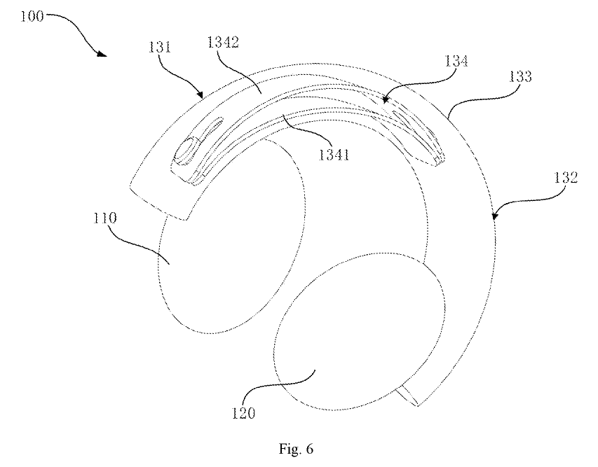

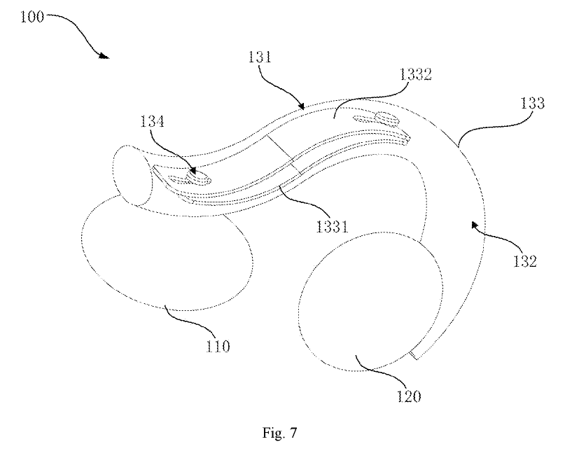

In some realizable ways, as shown in FIGS. 2A to 7, the ear clip part 130 of the embodiment of the disclosure includes a wrapping member 133 and a deformation assembly 134. The deformation assembly 134 is arranged in an inner cavity of the wrapping member 133 and located on the anterior ear section 131, and includes a first deformation member 1341 and a second deformation member 1342, both of which are curved, and the second deformation member 1342 has a different bending radius from the first deformation member 1341, and the second deformation member 1342 is arranged in a stacked manner with the first deformation member 1341, and located on the side of the first deformation member 1341 facing away from the ear 200. Both ends of the second deformation member 1342 are slidably connected to both ends of the first deformation member 1341 respectively, and the second deformation member 1342 is adapted for driving the first deformation member 1341 to deform under an external force.

In practical implementation, the ear clip part 130 is adjusted into a first form and a second form by changing bending directions of the first deformation member 1341 and the second deformation member 1342. In the first form, the bending radius of the second deformation member 1342 is smaller than that of the first deformation member 1341, and the bending direction of the second deformation member 1342 is changed by pressing the second deformation member 1342 so as to drive both ends of the second deformation member 1342 to slide outwards relative to both ends of the first deformation member 1341, and further drive the first deformation member 1341 to bend reversely, and here, the bending radius of the first deformation member 1341 is smaller than that of the second deformation member 1342. In this way, through the connection relationship between the both ends of the first deformation member 1341 and the second deformation member 1342, the first deformation member 1341 and the second deformable member 1342 are mutually limited to define the bending radian of the pre-auricular segment 131 in the first and second forms. At the same time, the both ends of the first deformation member 1341 slide with the both ends of the second deformation member 1342, so that the first deformation member 1341 and the second deformation member 1342 can deform at the same time only by applying an external force to the second deformation member 1342, and the operation is simple and convenient.

The wrapping member 133 can be of a soft material such as rubber, which can change shape with the deformation of the deformation assembly 134, and at the same time, it is beneficial to improving the wearing comfort of the user, and the specific material of the wrapping member 133 is not limited in the embodiment of the disclosure. Meanwhile, a length of the deformation assembly 134 may be one fifth, one quarter, one third or one half of the length of the ear clip part 130, so as to be able to switch the ear clip part 130 between the first form and the second form, which is not limited here by the embodiment of the disclosure.

In some realizable ways, as shown in FIGS. 2A to 5, both ends of the first deformation member 1341 of the embodiment of the disclosure are provided with limiting posts 1343; both ends of the second deformation member 1342 are provided with limiting slots 1344 corresponding to the limiting posts 1343, and each limiting slot of the limiting slots 1344 is provided with a first limiting section 1344a and a second limiting section 1344a, which are arranged along an extension direction of the second deformation member 1342 and connected; and the limiting post 1343 is adapted to move between the first limiting section 1344a and the second limiting section 1344b.

In some embodiments, the limiting post 1343 is inserted into the limiting slot 1344 and slidably connected to the limiting slot 1344, so that the both ends of the first deformation member 1341 are slidably connected to the both ends of the second deformation member 1342. The limiting slot 1344 includes a first limiting section 1344a and a second limiting section 1344b. The first limiting section 1344a and the second limiting section 1344b are connected. In the first form, the limiting post 1343 is located in the first limiting section 1344a, and in the second form, the limiting post 1343 is located in the second limiting section 1344b. By means of the first limiting section 1344a and the second limiting section 1344b, the bending radians of the first deformation member 1341 and the second deformation member 1342 in the two forms can be limited.

In some realizable ways, as shown in FIGS. 2A, 2B and 3, the limiting slot 1344 of the embodiment of the disclosure further includes a transition connecting section 1344c, which is located between the first limiting section 1344a and the second limiting section 1344b, and a width of each of the first limiting section 1344a and the second limiting section 1344b is greater than a width of the transition connecting section 1344c.

It should be noted that the width of the transition connecting section 1344c can be arranged to be slightly larger than a diameter of the limiting post 1343, so that the limiting post 1343 can be prevented from sliding between the first limiting section 1344a and the second limiting section 1344b freely, and only when an external force is applied to the second deformation member 1342 can the limiting post 1343 slide to the first limiting section 1344a or the second limiting section 1344b through the transition connecting section 1344c, so as to ensure the stability of the ear clip part 130 in the first and second forms.

In some realizable ways, as shown in FIGS. 2A, 2B and 3, the limiting post 1343 of the embodiment of the disclosure includes a post body 1343a and a limiting head 1343b, where the post body 1343a is adapted to be arranged to pass through the first limiting section 1344a and the second limiting section 1344b; and the limiting head 1343b is arranged at a free end of the post body 1343a and is in limiting fit with the limiting slot 1344.

In practical implementation, a diameter of the limiting head 1343b is larger than that of the first limiting section 1344a and the second limiting section 1344b, and the post body 1343a passes through the first limiting section 1344a or the second limiting section 1344b and is connected to the limiting head 1343b, thus ensuring that the post body 1343a is always in the limiting slot 1344, preventing the limiting post 1343 from being disconnected from the limiting slot 1344 during sliding, which is beneficial to ensure the structural stability of the ear-clip earphone 100.

In some realizable ways, as shown in FIGS. 2A to 3, the deformation assembly 134 of the embodiment of the disclosure further includes a fixing sleeve (not shown) which is fitted around both ends of the first deformation member 1341 and the second deformation member 1342, and is configured for limiting both ends of the first deformation member 1341 and the second deformation member 1342.

In some embodiments, the bending radians of the first deformation member 1341 and the second deformation member 1342 can also be defined by the fixing sleeves. There are provided with two fixing sleeves, each fitted around an end of the first deformation member 1341 and the second deformation member 1342, and a sliding distance of the end of the second deformation member 1342 relative to the end of the first deformation member 1341 can be defined by the fixing sleeve, thereby defining the bending radians of the first deformation member 1341 and the second deformation member 1342.

In some realizable ways, as shown in FIGS. 2A to 3, both ends of the first deformation member 1341 in the embodiment of the disclosure are provided with first limiting slots, and both ends of the second deformation member 1342 are provided with second limiting slots; and the fixing sleeve is provided with a first limiting protrusion matched with the first limiting slot and a second limiting protrusion matched with the second limiting slot.

Specifically, the first limiting protrusion and the second limiting protrusion are respectively arranged on two opposite inner walls of the fixing sleeve, and structures of the first limiting slot and the second limiting slot can be the same as that of the limiting slot 1344. By sliding the first limiting protrusion and the second limiting protrusion in the first limiting slot and the second limiting slot respectively, the sliding distance between the both ends of the first deformation member 1341 and the second deformation member 1342 is limited, and then the bending radians of the first deformation member 1341 and the second deformation member are limited.

Meanwhile, the specific structures of the first and second limiting protrusions are not limited in this embodiment. For example, both the first and second limiting protrusions can be arranged in the same structure as the limiting post 1343, respectively on the two opposite inner walls of the fixing sleeve, and corresponding to the positions of the first and second limiting slots, or the first and second limiting protrusions can be integrally arranged, that is, a connecting column can be arranged in the fixing sleeve, and both ends of the connecting column are respectively connected to the two inner walls of the fixing sleeve, and the connecting column passes through the first limiting slot and the second limiting slot successively, and the both ends of the connecting column respectively form a first limiting protrusion and a second limiting protrusion, so that while positions of the first deformation member 1341 and the second deformation member 1342 can be limited, it can ensure that the fixing sleeve cannot fall off, so that stability of the connection between the fixing sleeve and the first deformation member 1341 and the second deformation member 1342 can be maintained, which is beneficial to improving the structural stability of the ear-clip earphone 100.

To sum up, the ear-clip earphone 100 provided by the embodiment of the disclosure includes a speaker unit 110, a main body part 120 and an ear clip part 130, both ends of which are connected to the speaker unit 110 and the main body part 120 respectively, the speaker unit 110 is located on a front side of the ear 200, and the main body part 120 is located on a back side of the ear 200, and the ear clip part 130 can be switched between a first form and a second form under an external force. In the first form, the speaker unit 110 and the main body part 120 jointly clamp the ear 200, and the speaker unit 110 is far away from the ear canal, so that the pressure on the ear canal can be reduced, and at the same time, the sound of the external environment can be heard, so that the speaker unit 110 is adapted for a relatively quiet environment. In the second form, the speaker unit 110 abuts against the tragus 13 and fits against the ear canal opening, so that the pressure on the auricle can be reduced, whereby the ear-clip earphone 100 is fixed on the ear 10 mainly through the speaker unit 110, and the sound played by the speaker unit 110 can be directly transmitted into the ear canal, so as to isolate the sound from the external environment, which is beneficial to improving the sound quality of the sound, and is adapted for noisy environments or when the user has high requirements on the sound quality of audio. Therefore, the ear-clip earphone 100 provided by the embodiment of the disclosure can not only ensure the user's wearing comfort, but also flexibly adjust the shape of the ear clip part 130 according to its use requirements and application scenarios, which is beneficial to expanding the application scenarios of the ear-clip earphone 100 and meeting different needs of the user.

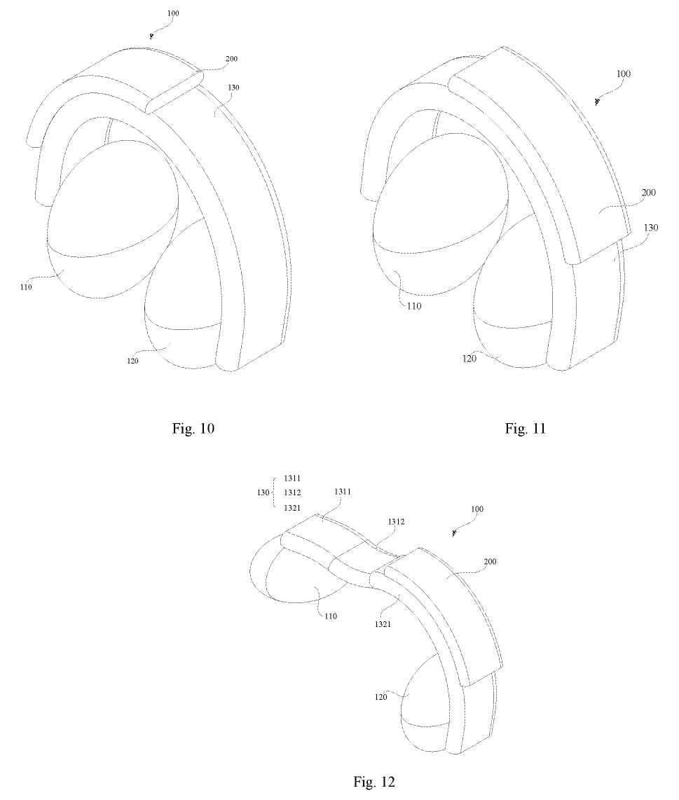

Referring to FIGS. 10 and 17, other implementations of the ear-clip earphone 100 are provided.

As mentioned above, the ear clip part 130 includes an pre-auricular segment 131 and an post-auricular segment 132. In some embodiments, the pre-auricular segment 131 includes a first ear clip component 1311 and a first deformation component 1312, and the post-auricular segment 132 includes a second ear clip component 1321 and a second deformation component 1322.

Referring to FIG. 12, the ear clip part 130 at least includes a second ear clip component 1321 and a first deformation component 1312, which are connected to each other so that some areas in the ear clip part 130 can deform to change the shape of the ear clip part 130. It needs to be noted that the second ear clip component 1321 and the first deformation component 1312 can be connected in such a way that an end of the second ear clip component 1321 can be directly connected to an end of the first deformation component 1312, or can be connected through an adapter.

The first deformation component 1312 is adapted for connecting to the speaker unit 110 of the earphone 100. In other words, an end of the first deformation component 1312 facing away from the second ear clip component 1321 is connected to the speaker unit 110. It needs to be noted that the connection in this embodiment can be understood either as direct connection or as indirect connection.

In view of the fact that in this embodiment, the speaker unit 110 is connected to the first deformation component 1312, so that when the shape of the first deformation component 1312 is changed, the position of the speaker unit 110 relative to the ear canal opening 18 will be changed at the same time, so that the earphone 100 can be freely switched between wearing comfort and sound quality effect.

For example, the first deformation component 1312 includes a first form and a second form, and a distance between the speaker unit 110 and the ear canal opening 18 in the first form is greater than a distance between the speaker unit 110 and the ear canal opening 18 in the second form. In other words, referring to FIG. 8, in the first form, the speaker unit 110 has a large distance to the ear canal opening 18, whereby the earphone 100 can be an open earphone, which can reduce the damage of the speaker unit 110 to the ear canal and improve the wearing comfort of the earphone 100.

Referring to FIG. 17, in the second form, the speaker unit 110 has a small distance to the ear canal opening 18, whereby the earphone 100 can be a semi-in-ear earphone or an in-ear earphone, which can reduce the distance between the speaker unit 110 and the ear canal opening 18 so as to improve the sound quality of the earphone 100.

It should be understood that the sound quality effect in this embodiment may include the volume of the earphone and the clarity of the sound quality of the earphone.

In order to ensure that the first deformation component 1312 can freely switch between the first and second forms, the earphone 100 provided by the embodiment of the present disclosure further includes a locking member 200, one end of which is movably connected to the second ear clip component 1321, and the other end of which is selectively connected to the first deformation component 1312, so that the first deformation component 1312 and the locking member 200 can switch between a locked state and an unlocked state.

As such, the selective connection can be understood that in some cases, the locking member 200 is connected to the first deformation component 1312, and in other cases, the locking member 200 is not connected to the first deformation component 1312.

For example, when the locking member 200 is connected to the first deformation component 1312, the first deformation component 1312 is locked, whereby the first deformation component 1312 cannot deform and is in the first form, so as to increase the distance between the speaker unit 110 and the ear canal opening to allow the earphone 100 to be an open earphone, thereby improving the wearing comfort of the earphone 100.

When the locking member 200 is not connected to the first deformation component 1312, the first deformation component 1312 is unlocked to release fixation of the first deformation component 1312, whereby the first deformation component 1312 can deform, and the first deformation component 1312 is in the second form, so as to shorten the distance between the speaker unit 110 and the ear canal opening, thereby further improving the sound quality effect of the earphone 100.

In this way, through the arrangement of the locking member 200, the first deformation component 1312 can be adjusted in this embodiment, so that the earphone 100 can more flexibly adapt to the shape and size of the ear canal of different users and the actual needs, and further, the earphone 100 can freely switch between wearing comfort and sound quality effect.

In the embodiment of the present disclosure, the main body part 120 is connected to an end of the second ear clip component 1321 away from the speaker unit 110; when the first deformation component 1312 is in the first form, the speaker unit 110 and the main body part 120 jointly clamp the ear 10 to form a stable wearing structure, which can effectively prevent the earphone 100 from slipping or loosening during wearing, and can maintain a stable form especially in the case of strenuous exercise or frequent head movements, thus providing the user with a continuous and uninterrupted listening experience.

In other embodiments, when the first deformation component 1312 is in the first form, the speaker unit 110 at least partially abuts against the concha cavity and clamps the ear 10 together with the main body part 120 located on the back side of the ear, further improving the wearing stability of the earphone 100.

When the first deformation component 1312 is in the second form, the speaker unit 110 can extend below the tragus. That is, the speaker unit 110 is tucked under the tragus, and the speaker unit 110 is similar to an earplug of an in-ear earphone. In this way, on the premise of shortening the distance between the speaker unit 110 and the ear canal opening 18, the earphone 100 can be fixed to the ear, thus improving the wearing stability of the earphone 100.

In one possible implementation, referring to FIGS. 11 and 12, when the locking member 200 moves in a direction away from the first deformation assembly 1312, the locking member 200 is separated from at least part of the first deformation assembly 1312, so that the first deformation assembly 1312 and the locking member 200 are in an unlocked state.

Referring to FIG. 10, when the locking member 200 moves in a direction towards the first deformation component 1312, the locking member 200 is connected to the first deformation component 1312, so that the first deformation component 1312 and the locking member 200 are in a locked state.

With this arrangement, the locking and unlocking of the first deformation component 1312 with the locking member 200 can be easily realized by simply moving the locking member 200. This design enables the earphone 100 to quickly adapt to different wearing requirements and improve the efficiency of wearing the earphone.

It should be understood that the locking member 200 and the first deformation component 1312 can be in other manners, for example, the locking member 200 can also be directly engaged with the first deformation component 1312, for example, when the shape of the first deformation component 1312 needs to be fixed, the locking member 200 can be snap-fitted with the first deformation component 1312. For another example, when the shape of the first deformation assembly 1312 needs to deform, the locking member 200 can be removed, and then the shape of the first deformation assembly 1312 can be adjusted.

In an embodiment in which the locking member 200 and the second ear clip component 1321 are movably connected, in an example, one end of the locking member 200 is slidably arranged on the second ear clip component 1321. In this way, during the movement of the locking member 200, the locking member 200 can be supported by the second ear clip component 1321, which ensures the stability and accuracy of the locking and unlocking process of the locking member 200.

In order to realize the sliding connection between the locking member 200 and the second ear clip component 1321, a sliding protrusion and a sliding slot can be provided to engage with one another. For example, one of the locking member 200 and the second ear clip component 1321 is provided with a sliding protrusion (not shown), and the other of the locking member 200 and the second ear clip component 1321 is provided with a sliding slot (not shown); the sliding protrusion is slidably arranged in the sliding slot.

The close cooperation between the sliding protrusion and the sliding slot provides accurate guidance for the locking member 200, ensures the stability and accuracy of the locking member in the moving process, and avoids the possible deviation or shaking of the locking member in the sliding process. At the same time, the design of the sliding protrusion and the sliding slot is relatively simple, and they are easy to be manufactured and processed so that the production cost is reduced.

In another example, one end of the locking member 200 is rotatably connected to the second ear clip component 1321. For example, one of the locking member 200 and the second ear clip component 1321 is provided with a rotating slot, and one of the locking member 200 and the second ear clip component 1321 is provided with a rotating shaft, so that the locking member 200 and the second ear clip component 1321 can be movably connected by means of the rotating shaft rotating in the rotating slot.

It should be understood that when it needs to separate the locking member 200 from the second ear clip component 1321, the locking member 200 can be controlled to rotate around the rotation axis to unlock the locking member 200, whereby, a rotation angle of the locking member 200 can be freely determined according to the actual situation. For example, the rotation angle of the locking member 200 can be 180 degrees, so that the rotated locking member 200 can be arranged to fit against the second ear clip component 1321, so that the locking member 200 will not occupy any additional space, which improves the utilization rate of space and the aesthetics of the earphone 100.

In one possible implementation, when the first deformation component 1312 and the locking component 200 are in the locked state, the locking component 200 is located on the first deformation component 1312 and is arranged to fit against the first deformation component 1312. In other words, the shape of the locking member 200 is adapted to the shape of the first deformation component 1312, so that opposite surfaces of the locking member 200 and the first deformation component 1312 are arranged to fit against each other. In this way, the stability of the locking state can be ensured, the locking looseness caused by external forces can be reduced, and the shape of the first deformation component 1312 can be prevented from being changed during use, thereby ensuring the wearing comfort and sound quality effect of the earphone 100. It should be understood that the locking member 200 is located on the first deformation component 1312 and arranged to fit against the first deformation component 1312, may be that the locking member 200 can completely in compliance with the first deformation component 1312 to prevent the first deformation component 1312 from being deformed in the first form.

The speaker unit 110 and the first deformation component 1312 may be directly connected or indirectly connected. For example, the earphone 100 further includes a first ear clip component 1311, which is provided on a side of the first deformation component 1312 away from the second ear clip component 1321. That is, the speaker unit 110 is connected to the first deformation component 1312 through the first ear clip component 1311, where the first ear clip component 1311 can be formed of a hard material, which can facilitate the speaker unit 110 to maintain a specific shape, avoid the speaker unit 110 from being squeezed with the tragus or concha cavity of the ear, and improve the wearing comfort of the earphone 100.

In the embodiment of this disclosure, the other end of the locking member 200 can be selectively connected to the first ear clip component 1311, so that both the locking member 200 and the first ear clip component 1311 are formed of hard materials, which can facilitate the connection between the locking member 200 and the first ear clip component 1311.

When the earphone 100 includes the first deformation component 1312 and the first ear clip component 1311, and the first deformation component 1312 and the locking member 200 are in the locked state, the locking member 200 is arranged to fit against the first deformation component 1312 and at least part of the first ear clip component 1311. That is, the locking member 200 is arranged to fit against the first deformation component 1312 and a part of the first ear clip component 1311, or the locking member 200 is arranged to fit against the first deformation assembly 1312 and the entire first ear clip assemblies 1311. In this way, the design flexibility of the earphone 100 can be improved on the premise of ensuring the stability of the connection between the first deformation component 1312 and the locking member 200.

Whereby, there are many options for the connection between the other end of the locking member 200 and the first ear clip component 1311.

In an example, the shapes of the opposite surfaces of the locking member 200 and the first ear clip component 1311 are matched, and the locking member 200 and the first ear clip component 1311 can be locked by virtue of their mutual compliance and mutual abutment.

In another example, the locking member 200 and the first ear clip component 1311 can also be connected by a magnetic member. For example, the locking member 200 is provided with a first magnet, and the first ear clip component 1311 is provided with a second magnet. The magnetic properties of the first magnet and the second magnet are opposite, so that the locking member 200 and the first ear clip component 1311 can be stably connected by means of the principle that opposite magnetic poles attract each other. In the use process, only the locking member 200 needs to be close to the first ear clip component 1311, and the magnetic force will automatically attract them and firmly connect them together. This connection method is fast and simple, which greatly improves the user's experience.

In one possible implementation, one of the locking member 200 and the second ear clip component 1321 is provided with a locking slot 150, and the other of the locking member 200 and the second ear clip component 1321 is provided with an elastic protrusion 160; when the elastic protrusion 160 is engaged with the locking slot 150, the first deformation component 1312 and the locking member 200 are in the locked state.

In order to describe the connection mode of the locking member 200 and the second ear clip component 1321 in detail, a locking slot 150 formed in the second ear clip component 1321 and an elastic protrusion 160 formed on the locking member 200 are taken as an example.

The elastic protrusion 160 can move in the direction towards the second ear clip component 1321, so that the elastic protrusion 160 protrudes from the locking member 200; the elastic protrusion 160 can also move in a direction away from the second ear clip component 1321, so that the elastic protrusion 160 is retracted to the locking member 200. For example, the elastic protrusion 160 may include an elastic member and a protruding member connected to the elastic member, while the locking member 200 may include an inner cavity and a through hole communicating with the inner cavity, and the elastic protrusion is arranged in the inner cavity and can extend from or retract into the inner cavity.

As described above, the embodiment of the present disclosure provides an earphone, where a first deformation member is connected to a speaker unit of the earphone, and the first deformation member can deform and has a first form and a second form; and deformation and form maintenance of the first deformation member are controlled by the locking member, for example, when the locking member is connected to the first deformation member, the first deformation member is locked, whereby, the first deformation member cannot deform and is in the first form, so as to increase a distance between the speaker unit and the ear canal opening, and further improve the wearing comfort of the earphone; when the locking member is not connected to the first deformation member, the first deformation member is unlocked, whereby the first deformation member can deform and be in the second form, so as to reduce the distance between the speaker unit and the ear canal opening, and further allow the earphone to be a semi-in-ear earphone or an in-ear earphone, so as to improve the sound quality effect of the earphone. With this arrangement, through the adjustability of the first deformation component, the earphone can be more flexibly adapted to the shape and size of the ear canal of different users and the actual needs, so that the earphone can be freely switched between wearing comfort and sound quality effect.

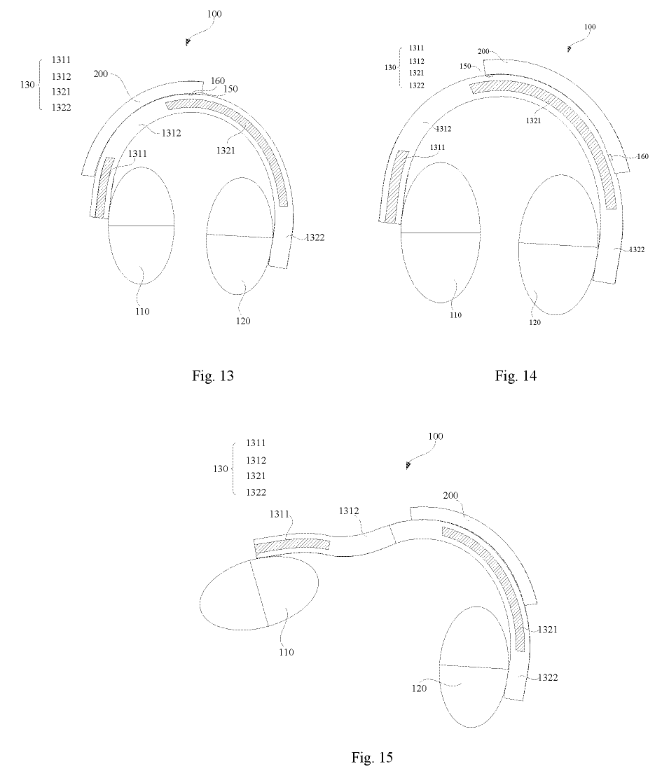

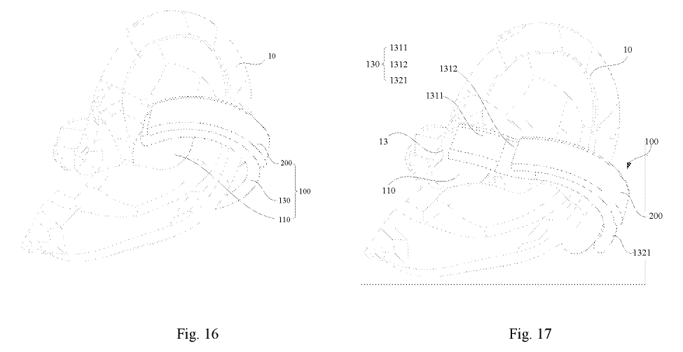

Referring to FIG. 13, in the first form, the elastic protrusion 160 protrudes from the locking member 200 and engages in the locking slot 150. When it needs to change from the first form to the second form, when a force is applied to the locking member 200, the elastic protrusion 160 disengages from the locking slot 150, and under a compression action of the second ear clip component 1321, the elastic protrusion 160 retracts into the locking member 200 and moves in the direction away from the first deformation component 1312 along with the locking member 200, as shown in FIG. 14.

When it needs to change from the first form to the second form, that is, from the state shown in FIG. 15 to the state shown in FIG. 13, when a force is applied to the locking member 200, the locking member 200 moves towards the first deformation component 1312. When the elastic protrusion 160 of the locking member 200 moves to the locking slot 150, the elastic member is no longer compressed, and the elastic protrusion 160 protrudes from the inner cavity of the locking member 200 under an elastic restoring force of the elastic member, and is engaged in the locking slot 150, the state of which is shown in FIG. 12.

According to the embodiment of the present disclosure, the elastic protrusion 160 can protrude from or retract into the locking member 200 as required, which enables the earphone 100 to flexibly switch between different forms. The user can switch forms through simple operations (such as applying a force) without complicated adjustment or additional tools.

It should be understood that the side wall of the locking slot 150 can be a guide wall, so that the guide wall provides a clear path for the elastic protrusion 160 to find and slide into the locking slot 150 more accurately. In addition, the guide wall can also reduce the friction and resistance between the elastic protrusion 160 and the wall of the slot during sliding in or out, reduce the wear between the elastic protrusion 160 and the wall of the slot of the locking slot 150, and prolong the service life of the earphone 100.

In the embodiment of the present disclosure, the ear clip part 130 may further include a second deformation component 1322, which is arranged between the main body part 120 and the second ear clip component 1321, that is, the main body part 120 is connected to the second ear clip component 1321 through the second deformation component 1322. In this way, in the process of wearing the earphone 100, the setting position of the main body part 120 can be finely adjusted according to the shapes and sizes of different users' ears, so that the main body part 120 can be in better compliance with the back side of the ear, thereby improving the clamping force of the main body part 120 and the speaker unit 110 on the helix and enhancing the stability of the earphone 100.

In addition, the flexible design of the second deformation component 1322 enables the main body part 120 to be adaptively adjusted according to the ear contours of different users. This adaptive adjustment reduces the pressure on the ear caused by the earphone 100, improves the wearing comfort, and enables the user to maintain a pleasant experience when wearing the earphone for a long time.

It should be understood that individual parts of the ear clip part 130 can be prepared separately and then assembled together. Besides, there are other manners.

In one possible implementation, the earphone 100 includes a flexible housing; the second ear clip component 1321 and the first ear clip component 1311 are arranged in the flexible housing at an interval, where an area of the flexible housing between the second ear clip component 1321 and the first ear clip component 1311 constitutes the first deformation component 1312.

In other words, the ear clip part 130 of the earphone 100 is prepared by a secondary injection molding process. For example, the second ear clip component 1321 and the first ear clip component 1311 are formed by injection molding of a material with a relatively high hardness, and then corresponding parts are arranged on the second ear clip component 1321 and the first ear clip component 1311. The material of the second ear clip component 1321 and the first ear clip component 1311 includes any one of acrylonitrile butadiene styrene (ABS), polystyrene (PS) and polymethylmethacrylate (PMMA).

Then, by using the secondary injection molding process, outer portions of the second ear clip component 1321 and the first ear clip component 1311, and an area between the second ear clip component 1321 and the first ear clip component 1311 are injected again to form the whole flexible housing, and the material of the flexible housing is soft. The area between the second ear clip component 1321 and the first ear clip component 1311 constitutes the first deformation component 1312.

The material of the flexible housing can include any one of thermoplastic elastomer (TPE), thermoplastic rubber (TPR) or thermoplastic polyurethane (TPU).

It should be noted that when the ear clip part 130 of the earphone 100 includes the second deformation component 1322, an area of the flexible housing on a side of the second ear clip component 1321 away from the first ear clip component 1311 constitutes the second deformation component 1322.

In this embodiment, the earphone 100 can be freely switched between an open earphone and an in-ear earphone through forming and matching mode between the hard material and the soft material, and skillfully matched with the locking member 200, thus realizing the switching of functional scenes with acoustic effect, and giving good consideration to the advantages of the respective product types of the open earphone and the in-ear earphone, where the in-ear earphone includes a semi-in-ear earphone and a full-in-ear earphone.

In addition, the earphone 100 also has the advantages of simple manufacturing principle and miniaturization and lightweight wearable products.

Each embodiment or implementation in this specification is described in a progressive way, and each embodiment focuses on the differences from other embodiments, so it is only necessary to refer to the same and similar parts between individual embodiments.

In the description of the embodiment of this application, it should be noted that unless otherwise specified and limited, the terms "fitting", "connected" and "connection" should be broadly understood, for example, they can be fixed connection, indirect connection through an intermediary, internal communication between two elements or interaction between two elements. For those skilled in the art, the specific meanings of the above terms in the embodiment of this application can be understood according to the specific situation.

Devices or elements referred to in the embodiments or implied in this application must have a specific orientation, be constructed and operated in a specific orientation, and therefore cannot be understood as limitations to the embodiments of this application. In the description of the embodiments of the disclosure, the meaning of "multiple" is two or more, unless it is precisely and specifically specified otherwise.

The terms "first", "second", "third", "fourth" and the like (if any) in the description and claims of the embodiment of the disclosure and the above drawings are used to distinguish similar objects, and are not necessarily used to describe a specific order or sequence. It should be understood that the data thus used can be interchanged under appropriate circumstances, so that the embodiments of the disclosure described herein can be implemented in other orders than those illustrated or described herein, for example.

Furthermore, the terms "including" and "having" and any variations thereof are intended to cover non-exclusive inclusion, for example, a process, method, system, product or equipment that includes a series of steps or units is not necessarily limited to those explicitly listed, but may include other steps or units not explicitly listed or inherent to such processes, methods, products or equipment.

The term "multiple" herein refers to two or more. In this paper, the term "and/or" is only a kind of relationship describing the related objects, which means that there can be three kinds of relationships, for example, A and/or B, which can mean that A exists alone, A and B exist at the same time, and B exists alone.

It can be understood that various numerical numbers involved in the embodiments of the disclosure are only for the convenience of description and are not used to limiting the scope of the embodiments of the disclosure.

It can be understood that in the embodiment of the disclosure, serial number of the above-mentioned processes does not mean the order of execution, and the order of execution of each process should be determined according to its function and internal logic, and should not constitute any restrictions on the implementation process of the embodiment of the disclosure.

Other embodiments of the disclosure will easily occur to those skilled in the art after considering the specification and practicing the disclosure disclosed herein. This application is intended to cover any variations, uses or adaptations of this application, which follow the general principles of this application and include common sense or common technical means in this technical field that are not disclosed in this application. The specification and examples are to be regarded as exemplary only, with the true scope and spirit of the disclosure being indicated by the following claims.

It should be understood that this application is not limited to the precise structure described above and shown in the drawings, and various modifications and changes can be made without departing from its scope. The scope of this application is limited only by the appended claims.

What is claimed is:

1. An ear-clip earphone, comprising:
a speaker unit adapted to be arranged on a front side of an ear;
a main body part adapted to be arranged on a back side of the ear;
an ear clip part, both ends of which are respectively connected to the speaker unit and the main body part, wherein the ear clip part is configured to switch between a first form and a second form, in the first form, the speaker unit and the main body part jointly clamp the ear, and in the second form, the speaker unit abuts against the tragus.

2. The ear-clip earphone according to claim 1, wherein in the second form, the speaker unit further fits against an ear canal opening.

3. The ear-clip earphone according to claim 2, wherein the ear clip part comprises a pre-auricular segment located on the front side of the ear and a post-auricular segment located on the back side of the ear, and the pre-auricular segment is adapted to deform under an external force to enable the ear clip part to switch between the first form and the second form.

4. The ear-clip earphone according to claim 3, wherein:
the pre-auricular segment protrudes outward in a direction away from the ear when the ear clip part is in the first form, and the pre-auricular segment curves inward in a direction close to the ear when the ear clip part is in the second form, so that the speaker unit moves in a direction close to the tragus and the ear canal; and/or
the ear clip part comprises:
a wrapping member; and
a deformation assembly arranged in an inner cavity of the wrapping member and located in the pre-auricular segment, the deformation assembly comprising:
a first deforming member and a second deforming member, wherein both the first deformation member and the second deformation member are curved, and the second deformation member has a different bending radius from the first deformation member, the second deformation member is arranged in a stacked manner with the first deformation member and is located on a side of the first deformation member facing away from the ear, both ends of the second deformation member are slidably connected to both ends of the first deformation member respectively, and the second deformation member is adapted for driving the first deformation member to deform under an external force.

5. The ear-clip earphone according to claim 4, wherein:
both ends of the first deformation member are respectively provided with limiting posts;
both ends of the second deformation member are respectively provided with limiting slots corresponding to the limiting posts, and each limiting slot of the limiting slots is provided with a first limiting section and a second limiting section, which are arranged along an extension direction of the second deformation member and are connected; and
the limiting posts are adapted for moving between the first limiting section and the second limiting section.

6. The ear-clip earphone according to claim 5, wherein the limiting slot further comprises a transition connecting section located between the first limiting section and the second limiting section, and a width of each of the first limiting section and the second limiting section is greater than a width of the transition connecting section.

7. The ear-clip earphone according to claim 5, wherein the limiting post comprises:
a post body adapted to pass through the first limiting section and the second limiting section; and
a limiting head arranged at a free end of the post body and is in limiting fit with the limiting slot.

8. The ear-clip earphone according to claim 4, wherein the deformation assembly further comprises a fixing sleeve, which is fitted around both ends of the first deformation member and the second deformation member, and is configured for limiting both ends of the first deformation member and the second deformation member.

9. The earphone according to claim 8, wherein:
both ends of the first deformation member are provided with first limiting slots, and both ends of the second deformation member are provided with second limiting slots; and
the fixing sleeve is provided with a first limiting protrusion matched with the first limiting slot and a second limiting protrusion matched with the second limiting slot.

10. The ear-clip earphone according to claim 1, wherein a distance between the speaker unit and the ear canal opening in the first form is greater than that in the second form.

11. The ear-clip earphone according to claim 3, wherein the pre-auricular segment comprises a first ear clip component and a first deformation component, the post-auricular segment comprises a second ear clip component, and the ear-clip earphone further comprises:
a locking member, one end of which is movably connected to the second ear clip component, and the other end of which is selectively connected to the first deformation component, so that the first deformation component and the locking member switch between a locked state and an unlocked state,
wherein when the first deformation component and the locking member are in the locked state, the first deformation component is in the first form, and when the first deformation component and the locking member are in the unlocked state, the first deformation component is in the second form.

12. The ear-clip earphone according to claim 11, wherein:
the main body part is connected to an end of the second ear clip component away from the speaker unit;
the main body part and the speaker unit clamp the ear in the first form; and
the main body part extends below the tragus of the ear in the second form.

13. The ear-clip earphone according to claim 11, wherein:
the locking member is separated from at least part of the first deformation component when the locking member moves in a direction away from the first deformation component, so that the first deformation component and the locking member are in the unlocked state; and
the locking member is connected to the first deformation component when the locking member moves in a direction towards the first deformation component, so that the first deformation component and the locking member are in the locked state.

14. The ear-clip earphone according to claim 13, wherein:
one end of the locking member is slidably arranged on the second ear clip component; or
one end of the locking member is rotatably connected to the second ear clip component.

15. The ear-clip earphone according to claim 14, wherein one of the locking member and the second ear clip component is provided with a sliding protrusion, and the other of the locking member and the second ear clip component is provided with a sliding slot, and the sliding protrusion is slidably arranged in the sliding slot.

16. The ear-clip earphone according to claim 11, wherein:
the locking member is located on the first deformation component and is arranged to fit against the first deformation component when the first deformation component and the locking member are in the locked state; and/or
the first ear clip component is arranged on a side of the first deformation component away from the second ear clip component and the other end of the locking member is selectively connected to the first ear clip component.

17. The ear-clip earphone according to claim 16, wherein the locking member is arranged to fit against the first deformation component and at least part of the first ear clip component when the first deformation component and the locking member are in the locked state.

18. The ear-clip earphone according to claim 17, wherein:
one of the locking member and the second ear clip component is provided with a locking slot, and the other of the locking member and the second ear clip component is provided with an elastic protrusion; and
the first deformation component and the locking member are in the locked state when the elastic protrusion is engaged in the locking slot.

19. The ear-clip earphone according to claim 18, further comprising:
a flexible housing, in which the second ear clip component and the first ear clip component are arranged at an interval, wherein an area of the flexible housing between the second ear clip component and the first ear clip component constitutes the first deformation component.

20. The ear-clip earphone according to claim 19, wherein the post-auricular segment further comprises a second deformation component arranged between the main body part and the second ear clip component, and an area of the flexible housing on a side of the second ear clip component away from the first ear clip component constitutes the second deformation component.
